(19) United States
(12) Patent Application Publication
(10) Pub. No.: US 2014/0178710 A1
(43) Pub. Date: Jun. 26, 2014

(54) ALLOYING INTERLAYER FOR ELECTROPLATED ALUMINUM ON ALUMINUM ALLOYS

(71) Applicant: UNITED TECHNOLOGIES CORPORATION, Hartford, CT (US)

(72) Inventors: Lei Chen, South Windsor, CT (US); Mark R. Jaworowski, Glastonbury, CT (US); Curtis H. Riewe, Manchester, CT (US); Xiaomei Yu, Westport, CT (US)

(73) Assignee: UNITED TECHNOLOGIES CORPORATION, Hartford, CT (US)

(21) Appl. No.: 13/722,428

(22) Filed: Dec. 20, 2012

(51) Int. Cl. C25D 5/10; B32B 15/01

(52) U.S. Cl. CPC C25D 5/10; B32B 15/016
USPC 428/610; 428/654; 205/176; 205/104; 205/103

(57) ABSTRACT

An aluminum alloy component is protected by an electrodeposited aluminum coating. An electrodeposited intermediate aluminum-transition metal alloy and/or rare earth metal alloy layer between the aluminum alloy substrate and the protective coating enhances coating adhesion and corrosion resistance. The intermediate layer is formed by room temperature electrodeposition in ionic liquids.

### BACKGROUND

The application relates generally to coating of metallic substrates and more specifically to the use of a compositionally graded interlayer to enhance electrodeposited aluminum coating adhesion on aluminum alloys.

Aluminum alloys in general and high strength aluminum alloys in particular are prone to environmental attack. The alloys are chemically reactive and naturally form an oxide film in the presence of water and air. The oxide offers some protection but offers little resistance to galvanic and other corrosive attack. Pure aluminum is significantly resistant to corrosion, in particular, localized corrosion such as pitting. Thus, coating aluminum alloy components with pure aluminumis an effective method to counter corrosion.

Electrodeposition of aluminum on aluminum alloys from aqueous solutions is not possible because the electronegativity of aluminum in relation to water is such that hydrogen will form in deference to aluminum deposition in a plating bath. The only commercialized aluminum electroplating technology in the U.S. is Alumiplate™, which employs a bath that is pyrophoric (triethlyaluminum in solvent toluene) and operates above room temperature (at 100° C.). Such aluminum electroplating can be difficult and dangerous to implement due in part to the pyrophoric nature of the plating chemistry and use of organic solvents such as toluene. Toluene is currently listed by the U.S. Environmental Protection Agency (EPA) as a hazardous air pollutant (HAP).

Other advanced coatings processes have been developed but each has shortcomings. Thin film chemical vapor deposition (CVD), physical vapor deposition (PVD), and ion vapor deposition (IVD) cannot be used to deposit low porosity or dense coatings. Dense coating is preferred when corrosion protection of the substrate is desired. Recent advances in ionic liquids and related processes have shown promise for depositing aluminum coatings directly onto a substrate. Electroplating aluminum in room temperature ionic liquids has advantages of non-line-of-sight, green chemistry and absence of flammability issues over alternatives such as the Alumiplate process.

Aluminum coating adhesion on aluminum alloys is always an issue. The aluminum oxide coating has been known to affect adhesion. Microstructural compatibility between the coating and substrate and interfacial stress gradients are other issues affecting coating integrity. A room temperature ionic liquid plating bath to coat high strength aluminum alloys is needed.

### SUMMARY

An aluminum alloy component can be coated with a protective aluminum coating by electrodeposition in an ionic liquid. An intermediate aluminum alloy interlayer, i.e. aluminum-transition metal or aluminum-rare earth metal alloy, between the component and protective coating enhances coating adhesion.

### BRIEF DESCRIPTION OF THE DRAWINGS

FIG. 1A is schematic showing an alloy interlayer between a top protective layer coating and a substrate.

FIG. 1B is an enlargement showing a possible multilayer structure of an alloy interlayer.

FIG. 2 is a schematic plot showing square wave pulses applied during electrodeposition of an alloy interlayer.

FIG. 3 is a schematic plot showing sawtooth wave pulses applied during electrodeposition of an alloy interlayer.

FIG. 4 is a schematic showing sawtooth pulse application during deposition of aluminum alloy interlayer followed by deposition of bulk aluminum protective layer.

FIG. 5 is a chart of an example plating process of the invention.

### DETAILED DESCRIPTION

Pure aluminum coatings are used in the art to provide anticorrosion protection for high strength aluminum and other alloys. The high specific strength and fatigue resistance of these alloys play major roles in aircraft construction and in the cold sections of an aircraft engine. Alclad aluminum products are protected by a more active, hence sacrificial aluminum alloy layer usually mechanically bonded to the alloy by pack rolling. Alclad products are generally in sheet form and cannot be used for the corrosion protection of components of more complex geometry. Other forms of aluminum coating applications including chemical vapor deposition (CVD) and physical vapor deposition (PVD) are useful but are difficult to scale up in larger industrial applications to apply dense protective aluminum coatings with the required thickness. Electroplating has been used in the art to apply protective aluminum coatings to high strength aluminum alloy components of all shapes. Aluminum is one of few metals that cannot be electrodeposited from aqueous solutions. During the plating process, water from the aqueous solution dissociates into hydrogen and oxygen at a voltage lower than that necessary to reduce the aluminum complex ions out of the solution to its metallic state. As mentioned above, the only commercial aluminum electroplating technology in the U.S. is Alumiplate which employs a pyrophoric bath containing triethylaluminum and toluene and operates above room temperature. The Alumiplate plating chemistry is pyrophoric and the entire process needs to be performed in a closed inert environment. In addition, one of the solvents, toluene, is classified as a hazardous air pollutant.

An attractive process to electroplate aluminum on bulk aluminum alloy and other alloy components is, according to an embodiment of the present invention, electrodeposition from a room temperature ionic liquid. Advantages over prior art are non-line-of-sight deposition, pollution-free (green) chemistry, and non-flammable process.

The interfacial compatibility and resulting adherence of a pure aluminum coating on, as an example, a high strength aluminum alloy, are sensitive to a number of factors. Aluminum alloys are chemically reactive with water and air and naturally form a dense oxide film subsequently. The oxide film can weaken the bonding of the coating due to interfacial structure mismatch or contaminants. In addition, since high strength aluminum alloys are heat treated to achieve desired mechanical properties, the alloy microstructures will typically not match that of an electrodeposited pure aluminum coating. It is known in the art that interfacial properties critical to coating adhesion include microstructural match, interfacial chemical/atomic bonding and interfacial stress gradients. An embodiment of the invention is to improve electrodeposited aluminum coating adhesion on high strength aluminum and other alloy substrates by electrodepositing an alloy interlayer between the bulk coating and substrate.

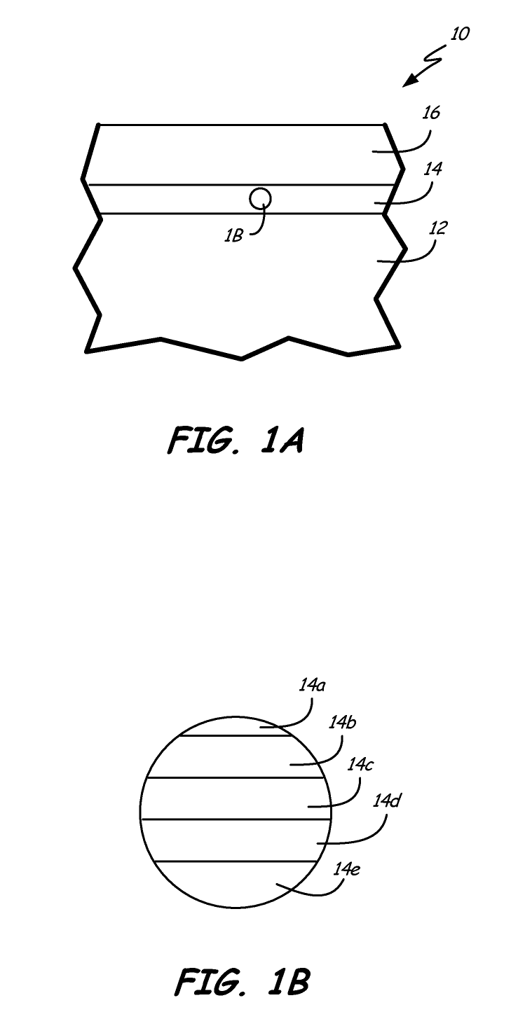

A schematic of inventive coating structure 10 is shown in FIG. 1A. Structure 10 comprises substrate 12, electrodeposited alloy interlayer 14 and electrodeposited aluminum protective layer 16. Substrate 12 may comprise a high strength aluminum alloy or any other alloy requiring a protective aluminum anticorrosion coating. Electrodeposited alloy interlayer 14 may comprise an Al-M alloy where M is at least one of a transition metal selected from the group consisting of Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt and Au, or at least one of a rare earth metal selected from the group consisting of Ce, Pr, Nd, Pm, Sm, Eu, Gd, Tb, Dy, Ho, Er, Tm, Yb and Lu. Alloy interlayer 14 may be a single layer or may be a multilayer structure as schematically indicated in FIG. 1B wherein layers 14a, 14b, 14c, 14d, 14e, etc. may be Al-M alloys wherein M may be a transition metal or a rare earth metal. Eletrodeposited aluminum protective layer 16 may comprise at least 99.9 wt percent aluminum. The alloy composition of alloy interlayer 14 may be constant through the thickness of each layer or may be compositionally graded, preferably with highest alloy concentrations at the interface with substrate 12 and decreasing through thickness toward the top of protective aluminum layer 16. Alloy compositions of interlayer 14 may be controlled during electrodeposition by varying the deposition parameters as well as by varying the concentration and chemistry of the plating solution.

Examples of the electrodeposition of Al-V, Al-Ti, and Al-Mn transition metal binary alloys from ionic baths are described in Tsuda et al., J. Mining and Metallurgy, 39 3 (2003), Tsuda et al., J. Electrochem. Soc., 150, C234 (2003) and Ruan et al., Acta Materialia, 57, 3810 (2009) respectively and incorporated herein by reference in their entirety.

Alloy interlayer 14 of the present invention is formed by codeposition of two or more elements from an ionic liquid plating bath preceding the deposition of protective aluminum coating 16 from the same or a different ionic liquid plating bath. The composition and microstructure of interlayer 14 may be controlled by modulating the codeposition by employing direct current, pulse and pulse reverse deposition in combinations thereof and baths with varying combinations of constituent metal elements. These and other aspects of the invention are discussed below.

As noted above, aluminum and its alloys can be electrodeposited from room temperature molten salts, i.e., ionic liquids. As an example, Lewis acid chloroaluminate alky-imidazolium chloride ionic liquid electrolyte may be electrochemically reducible to produce an Al coating. Specifically, 1-ethyl-3-methylimidazolium chloride ionic liquids have been favorable for electrodeposition of Al due to their relatively lower viscosity and better conductivity. In such a practice, dimeric chloroaluminate anions are the electroactive species to be reduced on the cathode to produce a metallic Al coating as depicted by reaction (1).

4Al₂Cl₇⁻+3ₑ⁻=Al+7AlCl₄⁻ (1)

Equilibrium potential of the reaction is given as

$${E}_{eq} = {E}^{0} + \frac{RT}{3 F} ln ( \frac{{a}_{{Al}_{2} {Cl}_{7}^{-}}^{4}}{{a}_{{AlCl}_{4}^{-}}^{7} {a}_{Al}} ) \qquad ( 2 )$$

where α_{Al}_{₂}_{Cl}_{₇}_{^{−}}, α_{AlCl}_{₄}_{^{−}} and α_{Al} are the activities of Al₂Cl₇⁻, AlCl₄⁻ and Al in the Al coating respectively.

Many useful room temperature ionic liquids can be formed using large non-symmetrical organic cations and inorganic anions for subsequent Al and Al-M alloy deposition. Examples of organic cations related to this invention include:

| Abbreviation | Cation |
|---|---|
| EMIM | 1-Ethyl-3-methylimidazolium |
| BMIM | 1-butyl-3-methylimidazolium |
| DMPI | 1,2-Dimethyl-3-propylimi |
| BP | N-Butylpyridinium |
| MP | Methylpyridinium |
| BTMA | Benzyltrimethylammonium |
| TMHA | Trimethylhexylammonium |
| TEA | Tetraethylammonium |

Except for underpotential deposition that occurs only on selected substrates with work functions greater than that of Al, the electrode potential at which Al is deposited is more negative than the equilibrium potential of reaction (1), i.e. an overpotential is required for Al deposition. The overpotential η is defined as the difference between the applied potential (Eₐₚₚ) and the equilibrium potential

η=Eₐₚₚ−E_{eq} (3)

In general, the deposition rate of an active species increases with the overpotential until the diffusion limitation of the species is reached. Consequently, alloy interlayer 16 composition may be tailored by controlling the deposition rate of each constituent metal via plating bath chemistry and concentration as well as deposition potential or current.

Aluminum is one of the most active metals. Thus, most alloying constituents considered in this application have more noble equilibrium potentials than Al. Therefore, the alloying elements selected in this application will likely deposit preferentially relative to Al at a given potential, where the overpotential of Al deposition is smaller compared to those more noble metals. This makes co-deposition of a graded Al-M alloy interlayer challenging because a pure Al coating is desired by design during the subsequent deposition of the final bulk aluminum coating. To bring the deposition potentials of the alloy constituents closer together to allow greater control of the competing Al and M deposition rates, the following approaches (embodiments) are disclosed besides the approach of depositing the interlayer and bulk coating in separate baths.

1. Alloying element (M) concentration control in the plating bath:

A metal chloride of the target alloying element may be added to the acidic ionic liquids consisting of AlCl₃ and alky- imidazolium chloride (>1:1 molar ratio to make a Lewis acid solution). For example, equation (4) shows titanium chloride dissolved in the chloroaluminate solution to form an electro-active species for the deposition of Ti, which discharges via the electrochemical reaction (5) on the cathode. The equilibrium potential of titanium chloroaluminate is depicted by equation (6), where the activity of Ti (α_{Ti}) in the alloy is less than unity. It is seen that a negative shift (i.e., a decrease) of the equilibrium potential of the alloying element will result from lowering the concentration of the anionic metal species (i.e. [Ti(AlCl₄)₃]⁻) in the solution. By controlling the concentration of the metal chloride added, a desired alloy interlayer can be attained. The methods include metering the alloying metal chloride precisely into the plating bath as a coating is deposited, or implementing anodic dissolution of the alloying metal by using an additional anode made of the targeted metal.

$$\begin{matrix}2 {Al}_{2} {Cl}_{7}^{-} + {TiCl}_{2} = {[ {Ti ( {AlCl}_{4} )}_{3} ]}^{-} + {AlCl}_{4}^{-} & ( 4 ) \\ {[ {Ti ( {AlCl}_{4} )}_{3} ]}^{-} + 2 {e}^{-} = Ti + 3 {AlCl}_{4}^{-} & ( 5 ) \\ {E}_{eq} ( {[ {Ti ( {AlCl}_{4} )}_{3} ]}^{-} ) = {E}^{0} ( {[ {Ti ( {AlCl}_{4} )}_{3} ]}^{-} ) + \frac{RT}{2 F} ln ( \frac{{a}_{{[ {Ti ( {AlCl}_{4} )}_{3} ]}^{-}}}{{a}_{{AlCl}_{4}^{-}}^{3} {a}_{Ti}} ) & ( 6 )\end{matrix}$$

2. Complex alloying element by anionic species:

When the cations of the alloying elements are complexed (i.e., attached) by an anionic species, the cations' effective activity is reduced. This can lead to a negative shift of its equilibrium potential and resulting deposition kinetics. Chloride is the anion of the chloroaluminate ionic liquid plating solution cited in this application. Other anions different from the primary anions of the ionic liquid solution may be selected to complex the alloying element to achieve controlled deposition rates and alloy compositions of the interlayer. The complexing anions include nitrates, thiocyanates, nitrites, formats, dicyanamides, chlorosulfonates, melthansoulfonates, and fluorinated anions.

3. Controlling the co-deposition by adjusting the polarization via employing variable current or potential regimes during plating:

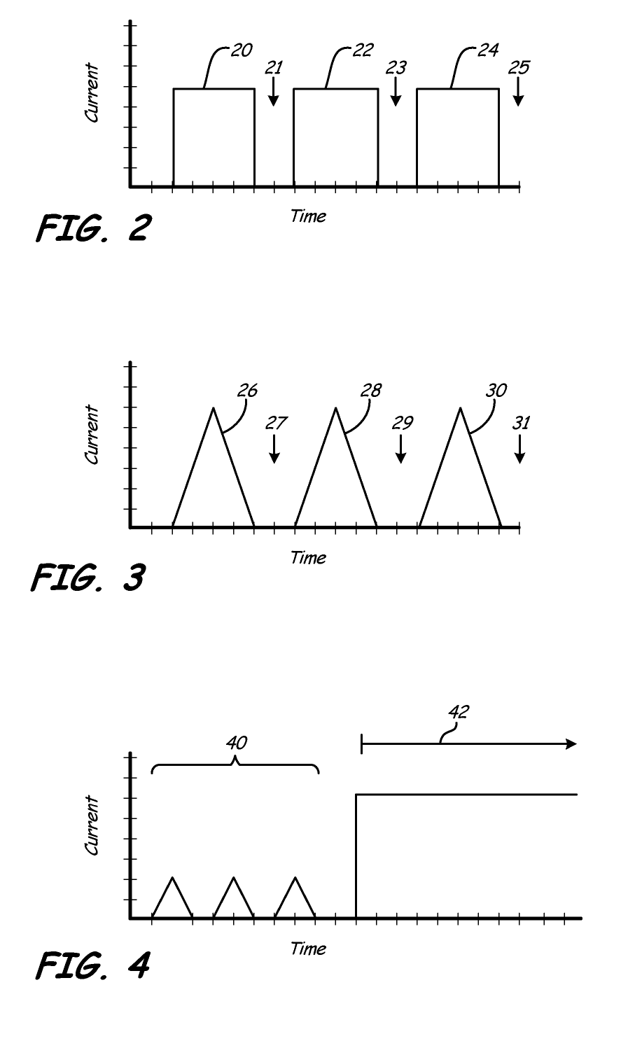

This method can be used alone or with method 1 and/or method 2. Higher polarization will increase the deposition rates. Because most alloying elements are more noble than Al, a higher overpotential will result in high Al content in the alloy. When the overpotential is high enough, the deposition of the alloying elements (i.e., the minor composition in the plating bath) is expected to be controlled completely by their diffusion in the electrolyte. A further increase in overpotential will then lead to the decrease of the alloying element in the resultant alloy interlayer. Depending on the desired composition of the interlayer, a modulated current or potential may therefore be applied to achieve a delicate control of the composition of the alloy interlayer. Pulse deposition examples are illustrated in FIGS. 2-4. The rest periods between pulses allow electro-active species to replenish on the cathode for deposition. During deposition of interlayer 14, due to high work function M deposits formed therein, underpotential deposition of Al may also result.

In FIG. 2, “square wave” pulses 20, 22, 24 allow Al-M alloy deposition when a current is applied to the plating cell. Gaps 21, 23, 25 between pulses are rest periods during which electroactive species can replenish on the cathode for subsequent deposition. In another pulsed plating scenario shown in FIG. 3, “saw tooth” pulses 26-30 with zero dwell at maximum current are applied to deposit Al-M alloy. As in FIG. 2, gaps 27, 29, 31 allow depositing species to replenish on the cathode for additional deposition. Under certain conditions of bath chemistry wherein the deposition potentials of aluminum and M alloy are similar, as mentioned above, protective aluminum layer 16 may be deposited on alloy interlayer 14 in a single operation by adjusting, at least, the deposition currents. In an overpotential scenario as schematically shown in FIG. 4, aluminum layer 16 is deposited during application of an overpotential in time period 42 following alloy interlayer 14 deposition by a “saw tooth” pulsed current application in time period 40.

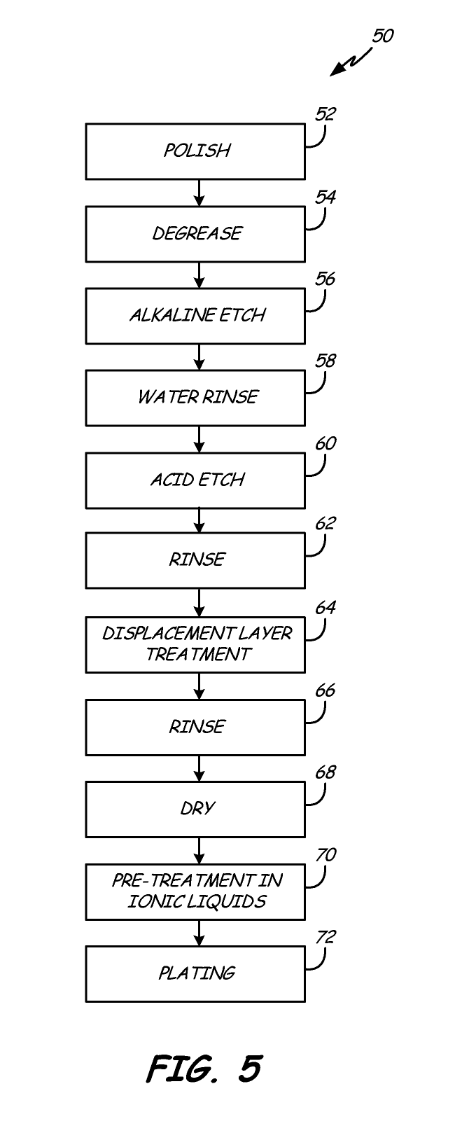

As noted earlier, as shown in FIGS. 1A and 1B, coating structure 10 comprises aluminum alloy substrate 12, electrodeposited alloy interlayer 14 and electrodeposited aluminum protective layer 16. Process 50 representing one embodiment for preparing inventive coating structure 10 is shown in FIG. 5.

To start the process 50, aluminum alloy substrate 12 is polished (step 52). Polishing step 52 comprises mechanical polishing or grit blasting using, for instance, 600-1200 grit abrasive.

The polished substrate is then degreased (step 54). Degreasing may be accomplished in an ultrasonic bath with hexane or other commercially available solvents.

Substrate 12 may then be given an alkaline etch to remove smut by dipping in a NaOH solution containing a desmutter, substances that promote the removal of smut. (step 56). A water rinse with deionized water may follow the alkaline etch (step 58).

In the next step, substrate 12 may be etched in an ultrasonic bath containing ammonium biflouride, nitric acid, and water according to ASTM B253-87 standard for electroplating aluminum (step 60). Substrate 12 may then be rinsed in deionized water (step 62).

A displacement layer treatment with zinc or tin may then follow in order to protect the activated Al alloy substrate from being re-oxidized(step 64). A double zincate treatment in a solution containing NaOH, ZnO, FeCl₃·6H₂O and Rochelle salts according to ASTM B253-87 is preferred for this step. Substrate 12 may then be given a deionized water rinse (step 66) followed by an air blow dry (Step 68).

In preparation for electrodeposition of alloy interlayer 14 and aluminum protective layer 16, substrate 12 may be immersed in an ionic liquid and either anodically etched or pulse reverse etched by applying corresponding current and current pulses (step 70).

Following the pre-treatment step in the ionic liquid, alloy interlayer 14 and final aluminum protective layer 16 may be electrodeposited as described earlier (step 72) in the same bath or in separate baths.

### Discussion of Possible Embodiments

The following are non-exclusive descriptions of possible embodiments of the present invention.

A coated metal component can include an aluminum alloy substrate; an electrodeposited intermediate aluminum alloy interlayer on the substrate; and an electrodeposited aluminum protective coating on the intermediate layer.

The component of the preceding paragraph can optionally include, additionally and/or alternatively any, one or more of the following features, configurations and/or additional components:
an alloy of Al and at least one metal selected from the group consisting of transitional metals and rare earth metals;
the transitional metals can be selected from the group consisting of Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, and Au and the rare earth metals may be selected from the group consisting of Ce, Pr, Nd, Pm, Sm, Eu, Gd, Tb, Dy, Ho, Er, Tm, Yb, and Lu;
the interlayer may comprise a multilayer structure;
the multilayer structure may comprise a plurality of aluminum alloy layers of different composition;
the multilayer structure may have a grated composition;
the graded composition of the layer may comprise a transition metal and/or rare earth metal content varying through the thickness of the layer with the transition metal and/or rare earth metal content highest at the aluminum alloy/substrate interface and lowest at the final aluminum alloy/protective coating interface;
the electrodeposited aluminum protective coating may be substantially pure aluminum;
the electrodeposited intermediate aluminum alloy interlayer may be formed by electrodeposition from an ionic liquid;
the electrodeposited intermediate aluminum alloy interlayer thickness may be from about 5 nm to about 10 μm;
the electrodeposited aluminum protective coating may have a thickness of at least one micron.

A method of forming a coated aluminum alloy component may comprise preparing the surface of the aluminum alloy component; electrodepositing an intermediate aluminum alloy interlayer on the surface of the component; and electrodepositing an aluminum protective coating on the intermediate aluminum alloy interlayer.

The method of the preceding paragraph can optionally include, additionally, and/or alternatively any, one or more of the following features, configurations and/or additional components:
preparing the surface may comprise mechanical polishing, degreasing and deoxidizing;
electrodepositing an intermediate aluminum alloy interlayer may comprise electrodeposition from an ionic liquid;
electrodepositing an aluminum protective coating may comprise electrodeposition from an ionic liquid;
the electrodeposited intermediate aluminum alloy interlayer may comprise an alloy of Al and at least one metal selected from the group consisting of transition metals and rare earth metals;
the transition metals may be selected from the group consisting of Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, and Au and wherein the rare earth metals are selected from the group consisting of Ce, Pr, Nd, Pm, Sm, Eu, Gd, Tb, Dy, Ho, Er, Tm, Yb, and Lu;
the interlayer may comprise a multilayer structure;
the multilayer structure may comprise a plurality of aluminum alloy layers of different compositions;
the multilayer structure may have a graded composition;
the graded composition may comprise transition metal content and/or rare earth metal content of the layer varying through the thickness of the layer with the transition metal content and/or rare earth metal content highest at the aluminum alloy/substrate interface, and lowest at the final aluminum alloy/protective coating interface;
the aluminum alloy layers may be formed by controlling the deposition rate of each constituent via plating bath chemistry and deposition potential or current, including direct current, or pulse, or pulse reverse deposition, or any combination of the above methods;
the aluminum protective coating may be substantially pure aluminum;
the intermediate aluminum alloy interlayer thickness may be from about 5 nm to about 10 μm.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A coated metal component comprising:
an aluminum alloy substrate;
an electrodeposited intermediate aluminum alloy interlayer on the substrate; and
an electrodeposited aluminum protective coating on the intermediate interlayer.

2. The coated component of claim 1, wherein the electrodeposited intermediate aluminum alloy interlayer comprises an alloy of Al and at least one metal selected from the group consisting of transition metals and rare earth metals.

3. The coated component of claim 2, wherein the transition metals are selected from the group consisting of Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, and Au and wherein the rare earth metals are selected from the group consisting of Ce, Pr, Nd, Pm, Sm, Eu, Gd, Tb, Dy, Ho, Er, Tm, Yb and Lu.

4. The coated component of claim 2, wherein the interlayer comprises a multilayer structure.

5. The coated component of claim 4, wherein the multilayer structure comprises a plurality of aluminum alloy layers of different composition.

6. The coated component of claim 5, wherein the multilayer structure has a graded composition.

7. The coated component of claim 6, wherein the graded composition comprises a transition metal and/or rare earth metal content of the layer varying through the thickness of the layer with the transition metal and/or rare earth metal content highest at the aluminum alloy/substrate interface and lowest at the final aluminum alloy/protective coating interface.

8. The coated component of claim 1, wherein the electrodeposited aluminum protective coating is substantially pure aluminum.

9. The coated component of claim 1, wherein the electrodeposited intermediate aluminum alloy interlayer is formed by electrodeposition from an ionic liquid.

10. The coated component of claim 1, wherein the electrodeposited intermediate aluminum alloy interlayer thickness is from about 5 nm to about 10 μm.

11. The coated component of claim 1, wherein the electrodeposited aluminum protective coating has a thickness of at least 1 micron.

12. A method of forming a coated aluminum alloy component, the method comprising:
preparing the surface of the aluminum alloy component;
electrodepositing an intermediate aluminum alloy interlayer on the surface of the component; and
electrodepositing an aluminum protective coating on the intermediate aluminum alloy interlayer.

13. The method of claim 12, wherein preparing the surface comprises mechanical polishing, degreasing and deoxidizing.

14. The method of claim 12, wherein electrodepositing an intermediate aluminum alloy interlayer comprises electrodeposition from an ionic liquid.

15. The method of claim 12, wherein electrodepositing an aluminum protective coating comprises electrodeposition from an ionic liquid.

16. The method of claim 12, wherein the electrodeposited intermediate aluminum alloy interlayer comprises an alloy of Al and at least one metal selected from the group consisting of transition metals and rare earth metals.

17. The method of claim 12, wherein the transition metals are selected from the group consisting of Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, and Au and wherein the rare earth metals are selected from the group consisting of Ce, Pr, Nd, Pm, Sm, Eu, Gd, Tb, Dy, Ho, Er, Tm, Yb and Lu.

18. The method of claim 16, wherein the interlayer comprises a multilayer structure.

19. The method of claim 18, wherein the multilayer structure comprises a plurality of aluminum alloy layers of different composition.

20. The method of claim 19, wherein the multilayer structure has a graded composition.

21. The method of claim 20, wherein the graded composition comprises transition metal content and/or rare earth metal content of the layer varying through the thickness of the layer with the transition metal content and/or rare earth metal content highest at the aluminum alloy/substrate interface, and lowest at the final aluminum alloy/protective coating interface.

22. The method of claim 19, wherein the aluminum alloy layers are formed by controlling the deposition rate of each constituent via plating bath chemistry and deposition potential or current, including direct current, or pulse, or pulse reverse deposition, or any combination of the above methods.

23. The method of claim 12, wherein the aluminum protective coating is substantially pure aluminum.

24. The method of claim 12, wherein the intermediate aluminum alloy interlayer thickness is from about 5 nm to about 10 μm.
